(19) United States
(12) Patent Application Publication
(10) Pub. No.: US 2018/0192420 A1
(43) Pub. Date: Jul. 5, 2018

(54) METHOD, APPARATUS AND SYSTEM

(71) Applicant: Nokia Solutions and Networks Oy, Espoo (FI)

(72) Inventors: Nan HAO, Beijing (CN); Naizheng ZHENG, Beijing (CN); Yuantao ZHANG, Beijing (CN)

(21) Appl. No.: 15/740,897

(22) PCT Filed: Jul. 2, 2015
(86) PCT No.: PCT/CN2015/083185

§ 371 Date: Dec. 29, 2017

(51) Int. Cl. H04W 72/04; H04L 5/00

(52) U.S. Cl. CPC H04W 72/0446; H04L 5/0037; H04L 5/0078

(57) ABSTRACT

There is provided a method comprising configuring at least one physical resource block of a first transmission time interval, comprising determining allocation of resource elements of the at least one physical resource block to at least one resource element group per physical resource block or per virtual resource block.

### FIELD

The present application relates to a method, apparatus, system and computer program and in particular but not exclusively, to physical control channel transmissions using a shortened transmission time interval (TTI).

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communications may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

In a wireless communication system at least a part of communications between at least two stations occurs over a wireless link. Examples of wireless systems comprise public land mobile networks (PLMN), satellite based communication systems and different wireless local networks, for example wireless local area networks (WLAN). The wireless systems can typically be divided into cells, and are therefore often referred to as cellular systems.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. An example of attempts to solve the problems associated with the increased demands for capacity is an architecture that is known as the long-term evolution (LTE) of the Universal Mobile Telecommunications System (UMTS) radio-access technology. The LTE is being standardized by the 3rd Generation Partnership Project (3GPP). The various development stages of the 3GPP LTE specifications are referred to as releases.

### SUMMARY OF THE INVENTION

In a first aspect there is provided a method comprising configuring at least one physical resource block of a first transmission time interval, comprising determining allocation of resource elements of the at least one physical resource block to at least one resource element group per physical resource block or per virtual resource block.

The at least one physical resource block may comprise a plurality of resource elements in the frequency domain and the OFDM symbols of the first time transmission interval in the time domain.

The first transmission time interval may comprise between 1 and 7 OFDM symbols.

The number of resource elements in the frequency domain may be predefined or dependent on the length of the first transmission time interval.

The virtual resource block may comprise a plurality of physical resource blocks.

The plurality of physical resource blocks of the virtual resource block may be frequency consecutive or frequency non-consecutive.

The number of the plurality of physical resource blocks of the virtual resource block may be predefined or dependent on the length of the first transmission time interval.

The number of resource elements associated with the at least one resource element group may be predefined or dependent on the length of the first transmission time interval.

The number of resource element groups allocated per physical resource block or per virtual resource block may be predefined or dependent on the index selection from resource element to resource element group mapping.

The number of resource elements in the at least one physical resource block of the first transmission time interval may be equal to the number of resource elements in a physical resource block of a second transmission time interval.

The first transmission time interval may be equal to the length of a slot of the second transmission time interval.

The method may comprise determining if a subframe of the second transmission time interval comprises a physical data control channel, and if not, causing transmission of a shortened physical data control channel in the subframe of the second transmission time interval.

A first slot of the second transmission time interval may have a first control channel element aggregation level and a second slot of the second transmission time interval may have a second control channel element aggregation level.

A physical control format indicator channel may comprise information, said information indicating the starting point of a shortened physical data control channel transmission.

In a second aspect there is provided an apparatus, said apparatus comprising means for configuring at least one physical resource block of a first transmission time interval, said means for configuring comprising means for determining allocation of resource elements of the at least one physical resource block to at least one resource element group per physical resource block or per virtual resource block.

The at least one physical resource block may comprise a plurality of resource elements in the frequency domain and the OFDM symbols of the first time transmission interval in the time domain.

The first transmission time interval may comprise between 1 and 7 OFDM symbols.

The number of resource elements in the frequency domain may be predefined or dependent on the length of the first transmission time interval.

The virtual resource block may comprise a plurality of physical resource blocks.

The plurality of physical resource blocks of the virtual resource block may be frequency consecutive or frequency non-consecutive.

The number of the plurality of physical resource blocks of the virtual resource block may be predefined or dependent on the length of the first transmission time interval.

The number of resource elements associated with the at least one resource element group may be predefined or dependent on the length of the first transmission time interval.

The number of resource element groups allocated per physical resource block or per virtual resource block may be predefined or dependent on the index selection from resource element to resource element group mapping.

The number of resource elements in the at least one physical resource block of the first transmission time interval may be equal to the number of resource elements in a physical resource block of a second transmission time interval.

The first transmission time interval may be equal to the length of a slot of the second transmission time interval.

The apparatus may comprise means for determining if a subframe of the second transmission time interval comprises a physical data control channel, and if not, causing transmission of a shortened physical data control channel in the subframe of the second transmission time interval.

A first slot of the second transmission time interval may have a first control channel element aggregation level and a second slot of the second transmission time interval may have a second control channel element aggregation level.

A physical control format indicator channel may comprise information, said information indicating the starting point of a shortened physical data control channel transmission.

in a third aspect there is provided an apparatus comprising at least one processor and at least one memory including a computer program code, the at least one memory and the computer program code configured to, with the at least one processor, cause the apparatus at least to configure at least one physical resource block of a first transmission time interval, comprising determining allocation of resource elements of the at least one physical resource block to at least one resource element group per physical resource block or per virtual resource block.

The at least one physical resource block may comprise a plurality of resource elements in the frequency domain and the OFDM symbols of the first time transmission interval in the time domain.

The first transmission time interval may comprise between 1 and 7 OFDM symbols.

The number of resource elements in the frequency domain may be predefined or dependent on the length of the first transmission time interval.

The virtual resource block may comprise a plurality of physical resource blocks.

The plurality of physical resource blocks of the virtual resource block may be frequency consecutive or frequency non-consecutive.

The number of the plurality of physical resource blocks of the virtual resource block may be predefined or dependent on the length of the first transmission time interval.

The number of resource elements associated with the at least one resource element group may be predefined or dependent on the length of the first transmission time interval.

The number of resource element groups allocated per physical resource block or per virtual resource block may be predefined or dependent on the index selection from resource element to resource element group mapping.

The number of resource elements in the at least one physical resource block of the first transmission time interval may be equal to the number of resource elements in a physical resource block of a second transmission time interval.

The first transmission time interval may be equal to the length of a slot of the second transmission time interval.

The apparatus may be configured to determine if a subframe of the second transmission time interval comprises a physical data control channel, and if not, causing transmission of a shortened physical data control channel in the subframe of the second transmission time interval.

A first slot of the second transmission time interval may have a first control channel element aggregation level and a second slot of the second transmission time interval may have a second control channel element aggregation level.

A physical control format indicator channel may comprise information, said information indicating the starting point of a shortened physical data control channel transmission.

In a fourth aspect, there is provided a computer program embodied on a non-transitory computer-readable storage medium, the computer program comprising program code for controlling a process to execute a process, the process comprising configuring at least one physical resource block of a first transmission time interval, comprising determining allocation of resource elements of the at least one physical resource block to at least one resource element group per physical resource block or per virtual resource block.

The at least one physical resource block may comprise a plurality of resource elements in the frequency domain and the OFDM symbols of the first time transmission interval in the time domain.

The first transmission time interval may comprise between 1 and 7 OFDM symbols.

The number of resource elements in the frequency domain may be predefined or dependent on the length of the first transmission time interval.

The virtual resource block may comprise a plurality of physical resource blocks.

The plurality of physical resource blocks of the virtual resource block may be frequency consecutive or frequency non-consecutive.

The number of the plurality of physical resource blocks of the virtual resource block may be predefined or dependent on the length of the first transmission time interval.

The number of resource elements associated with the at least one resource element group may be predefined or dependent on the length of the first transmission time interval.

The number of resource element groups allocated per physical resource block or per virtual resource block may be predefined or dependent on the index selection from resource element to resource element group mapping.

The number of resource elements in the at least one physical resource block of the first transmission time interval may be equal to the number of resource elements in a physical resource block of a second transmission time interval.

The first transmission time interval may be equal to the length of a slot of the second transmission time interval.

The process may comprise determining if a subframe of the second transmission time interval comprises a physical data control channel, and if not, causing transmission of a shortened physical data control channel in the subframe of the second transmission time interval.

A first slot of the second transmission time interval may have a first control channel element aggregation level and a second slot of the second transmission time interval may have a second control channel element aggregation level.

A physical control format indicator channel may comprise information, said information indicating the starting point of a shortened physical data control channel transmission.

In an fifth aspect there is provided a computer program product for a computer, comprising software code portions for performing the steps the method of the first aspect when said product is run on the computer.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example communication system comprising a base station and a plurality of communication devices;

FIG. 2 shows a schematic diagram, of an example mobile communication device;

FIG. 3 shows a schematic illustration of TTI granularity;

FIG. 4 shows a schematic illustration of a shortened TTI compared to a legacy TTI;

FIG. 5 shows a schematic illustration of a 0.5 ms TTI;

FIG. 6a shows an example of a SePDCCH transmission;

FIG. 6b shows an example of a SePDCCH transmission;

FIG. 7 shows a flowchart of a method of eREG to RE mapping.

FIG. 8a shows an example of eREG mapping for a SePDCCH transmission;

FIG. 8b shows an example of eREG mapping for a SePDCCH transmission;

FIG. 9 shows an example of PRB grouping;

FIG. 10 shows a schematic diagram of an example control apparatus;

### DETAILED DESCRIPTION

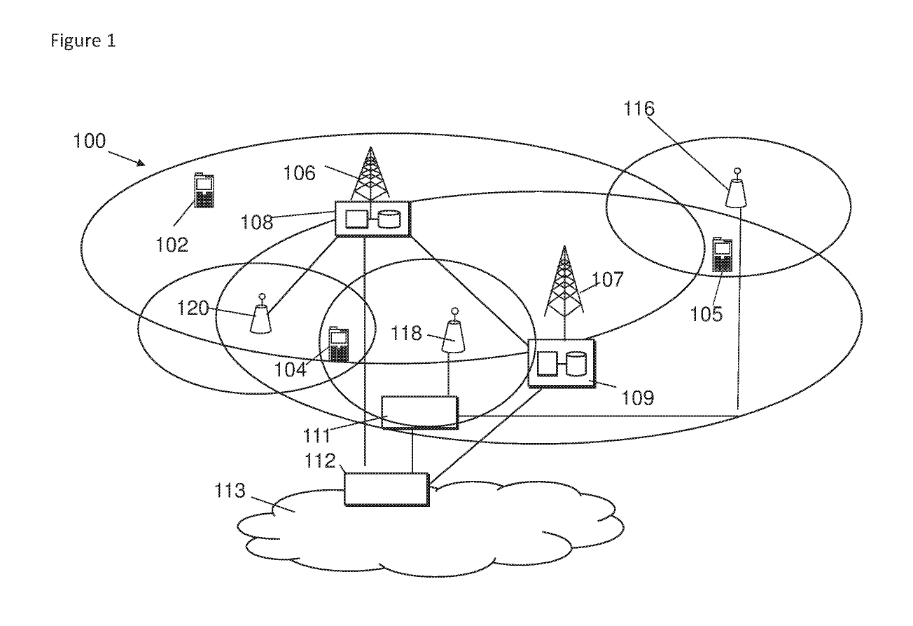

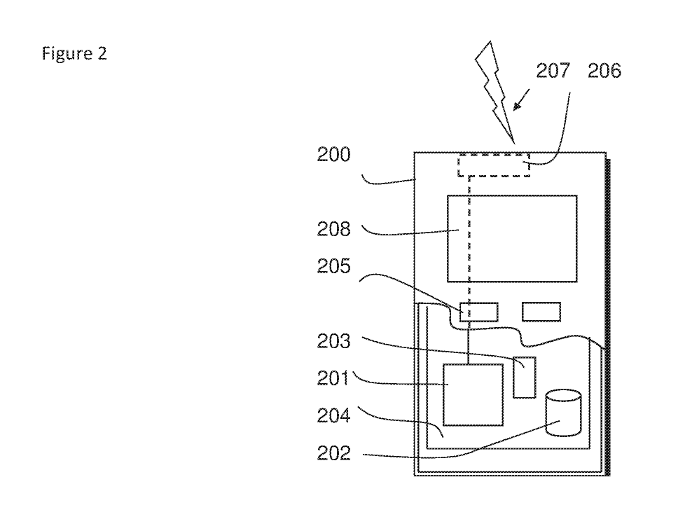

Before explaining in detail the examples, certain general principles of a wireless communication system and mobile communication devices are briefly explained with reference to FIGS. 1 to 2 to assist in understanding the technology underlying the described examples.

In a wireless communication system 100, such as that shown in FIG. 1, mobile communication devices or user equipment (UE) 102, 104, 105 are provided wireless access via at least one base station or similar wireless transmitting and/or receiving node or point. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

LTE systems may however be considered to have a so-called “flat” architecture, without the provision of RNCs; rather the (e)NB is in communication with a system architecture evolution gateway (SAE-GW) and a mobility management entity (MME), which entities may also be pooled meaning that a plurality of these nodes may serve a plurality (set) of (e)NBs. Each UE is served by only one MME and/or S-GW at a time and the (e)NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided. Smaller base stations 116, 118 and 120 may be part of a second network, for example WLAN and may be WLAN APs.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other examples of radio access system comprise those provided by base stations of systems that are based on technologies such as wireless local area network (WLAN) and/or WiMax (Worldwide Interoperability for Microwave Access). A base station can provide coverage for an entire cell or similar radio service area.

Round trip time (RTT) reduction is of interest and from the PHY-layer aspect, shortened transmission time interval (TTI) with fast processing and the potential impact to the specification is being considered. An LTE air interface delay may be considered to include three parts: a) processing delay, b) transmission delay and c) retransmission delay. If the processing delay of 1 TTI data is 1.5 TTI (1.5 ms in legacy with 1 ms=1 TTI legacy configuration), the retransmission delay of one TTI with 10% block error rate (BLER) is 0.8 TTI (8 TTI×10%) and the transmission delay is 1 TTI, then the overall delay will be 4.8 (1.5+1.5+1+0.8) TTI.

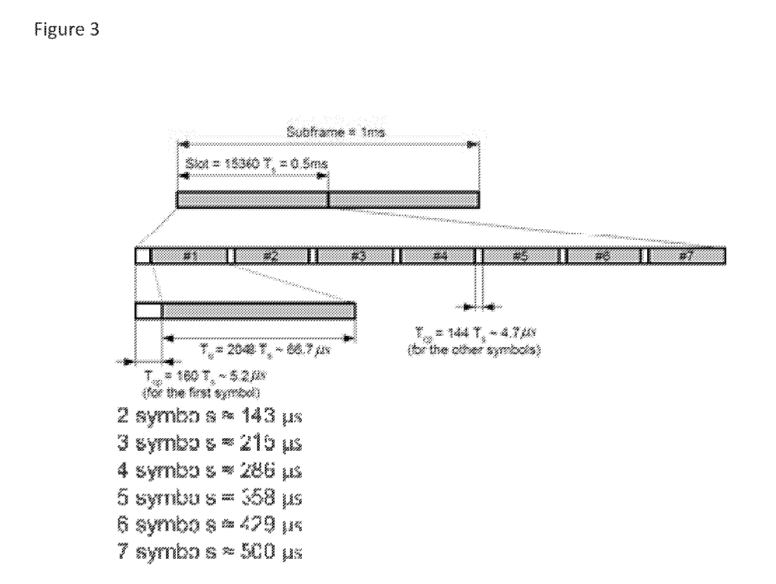

FIG. 3 shows the granularity of a TTI of 1 ms. The TTI comprises two slots of 0.5 ms. Each slot comprises 7 OFDM symbols.

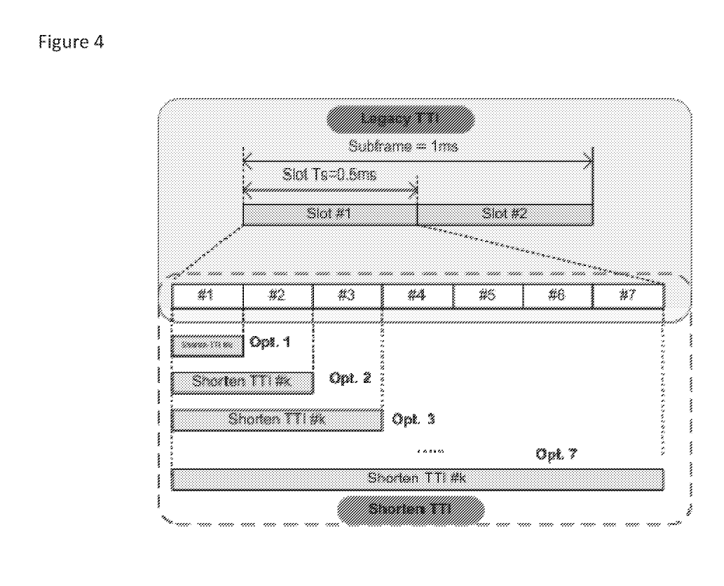

FIG. 4 shows a schematic illustration of shortened TTI granularity compared with legacy TTI. As shown in FIG. 4, the TTI may be a slot-level (0.5 ms) TTI, as indicated by Option 7 in FIG. 4, to symbol-level TTI (71.9/71.4us), as indicated by Option 1 in FIG. 4. TTI may be shortened to between 1 and 7 symbols, e.g. ODFM symbols, as shown by Options 1 to 7 of FIG. 4. If the legacy TTI can be shortened to e.g., 0.5 ms, or even shorter (e.g. 1 OFDM symbol duration such as that in Option 1 shown in FIG. 4), then the overall delay may be reduced greatly.

Considering backward compatibility and impact to specification, TTI reduction from 1 ms to slot-level (0.5 ms) may be suitable. The TTI reduction to the symbol-level may meet the requirements of 5G (with RTT of 1 ms), but the impact to the DL control channel and reference signal could be quite large which may require design and specification modifications. A shortened frame structure may also impact legacy LTE/LTE-A control channel and reference signals.

In the following, the potential issues of TTI reduction to slot-level (0.5 ms) are considered. In particular, the enhanced physical downlink control channel (ePDCCH) design with 1 slot duration is considered. However, the proposed methods may be applicable where the shortened TTI is equal to the length of one or more symbols of a legacy TTI, for example shortened TTI with 1/2/3/4/5/6 OFDM symbol TTI duration case as shown in FIG. 4, as well as any other suitable shortened TTI.

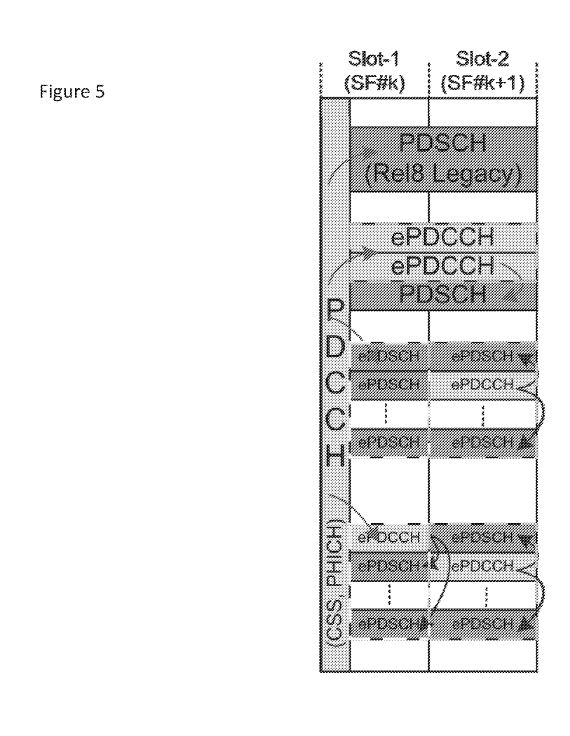

A shortened frame structure will introduce modification to the legacy LTE/LTE-A control channel and reference signals. FIG. 5 shows an example of a 0.5 ms TTI case. The enhanced physical downlink control channel (ePDCCH) application in TTI shortened to slot-level may be resource element (RE) allocated in terms of physical resource blocks (PRB), rather than legacy ePDCCH where the RE allocations of ePDCCH are in terms of a PRB pair.

To maintain backward compatibility with legacy TTI applications, the shortened TTI data resources may be frequency multiplexed with the legacy TTI data resources. FIG. 5 shows the backward compatibility in a single carrier may be maintained via frequency multiplexing between shorten TTI UEs and legacy TTI UEs. For legacy, the legacy physical downlink control channel (PDCCH) occupies the first 1, 2, 3 or 4 symbols. The physical downlink shared channel (PDSCH) or legacy ePDCCH spans and occupies the rest of symbols in one legacy TTI (which comprises total of 14 symbols, i.e. two slots comprising seven symbols). Either legacy PDCCH or ePDCCH can be used to indicate to the UE where the data payloads are carried in PDSCH.

For shortened TTI, in the example shown in FIG. 5, slot level TTI, the legacy PDCCH is presented in an even slot for backward compatibility operation. The legacy data channel PDSCH will be shortened correspondingly to a so-called ePDSCH, where, in an even slot it spans the symbols in one slot except the symbols occupied by legacy PDCCH, and in an odd slot it occupies all the symbols in one slot.

In the even slot, the data payloads carried in ePDSCH may be indicated either via legacy PDCCH or shortened ePDCCH in even slot. And in odd slot, the data payloads carried in ePDSCH may be indicated via shortened ePDCCH in odd slot.

In shorten TTI #k (legacy slot #1 in FIG. 5), shorten PDSCH duration has been reduced to (7—Dpdcch) symbols, in which the Dpdcch is the duration of PDCCH (e.g., with 3 symbol PDCCH region configuration, 4 symbols is given as shortened PDSCH in slot #1 shorten TTI frame structure, compared with that of 11 symbols duration in legacy LTE/LTE-A). Two options are shown for shorten TTI frame structure (e.g., slot level in FIG. 5). In the first option shorten ePDCCH (legacy EPDCCH duration equals to that of PDSCH) still exists as an supplement for legacy PDCCH in slot #1. In the second option, there is no shorten ePDCCH in slot #1. Both options may be adopted according to configuration.

In an embodiment, if the shortened TTI is a first TTI, a method may comprise determining if a subframe of a second TTI (e.g. a legacy TTI) comprises a physical data control channel, and if not, causing transmission of a shortened physical data control channel in the subframe of the second transmission time interval.

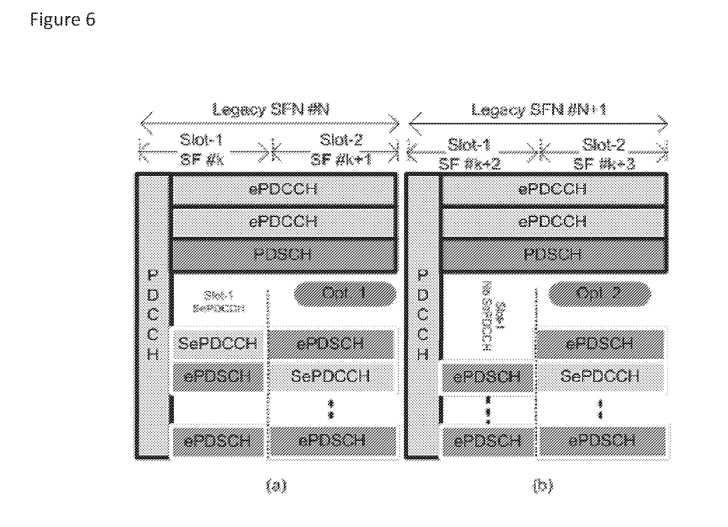

FIG. 6a shows an example of SePDDCH transmission for shortened TTI (option 1 as described with reference to FIG. 5). In an embodiment, shortened enhanced physical downlink control channel (SePDCCH) transmission occurs in each configured subframe (i.e. SePDCCH presents in both legacy even and odd number of slots).

FIG. 6b shows an example of SePDDCH transmission for shortened TTI (option-2 as described with reference to FIG. 5). A UE is configured such that if a current subframe contains PDCCH transmission, no SePDCCH will be transmitted. A UE would detect legacy PDCCH in subframes without SePDCCH. That is, no SePDDCH is transmitted if PDCCH is configured in a subframe. This approach may reduce control overhead.

In an embodiment, a physical control format indicator channel (PCFICH) may comprise information, said information indicating the starting point of a shortened physical data control channel transmission. PCFICH may indicate the starting point of SePDCCH for the even slot transmission option (slot #2 in FIG. 5). TTI duration may be configured in RRC configuration (or shorten TTI frame duration is implicitly indicated once the UE has been configured to follow the shorten frame structure).

In a case where TTI duration of 0.5 ms, the starting point (even slot of legacy configured subframe) within legacy TTI duration (1 ms) is 7th OFDM symbol (for example, as in the embodiment shown in FIG. 6b). In the odd slot for each legacy TTI, the starting point of SePDCCH may follow the legacy PCFICH indication for EPDCCH.

in an embodiment where the shortened TTI is a first TTI and the legacy TTI is a second TTI, a first slot of the second TTI may have a first enhanced control channel element (eCCE) aggregation level (AL) and a second slot of the second TTI may have a second eCCE AL. In an embodiment such as that shown in FIG. 6a, the aggregation level (AL) for SePDCCH in an odd slot may be different from the AL for a SePDCCH in an even slot, depending on the duration of PDCCH region. A base station, e.g. eNB, may separately configure a set of AL for odd subframes and a set of AL for even subframes. The search space for UE blind detection in each kind of subframe may be determined based on the configured aggregation level. The search space for each shortened TTI may be based on the legacy subframe index and UE cell radio network temporary identifier (C-RNTI). That is, the odd subframe and even subframe of the same legacy subframe would use the same parameters (subframe index and C-RNTI) to decide the search space.

For SePDCCH in both slots, the AL set of even and odd slots may depend on the PDCCH control region size. When the number of UE and/or number of PDCCH symbols is large, the odd slot may use a higher AL set compared with that of an even slot. The blind decoding time may be reduced.

A legacy LTE/LTE-A system has 16 enhanced resource element groups (eREGS) in a time domain consecutive PRB pair (144 REs/9). Considering RE to eREG mapping for a TTI of 0.5 ms, only 72 REs are available per PRB, and thus 8 different eREGs {0, 1, 2, 3, 4, 5, 6, 7} exist (legacy eREG has 9 REs, actual index of eREG should be configurable according to definition of number of REs in each eREG).

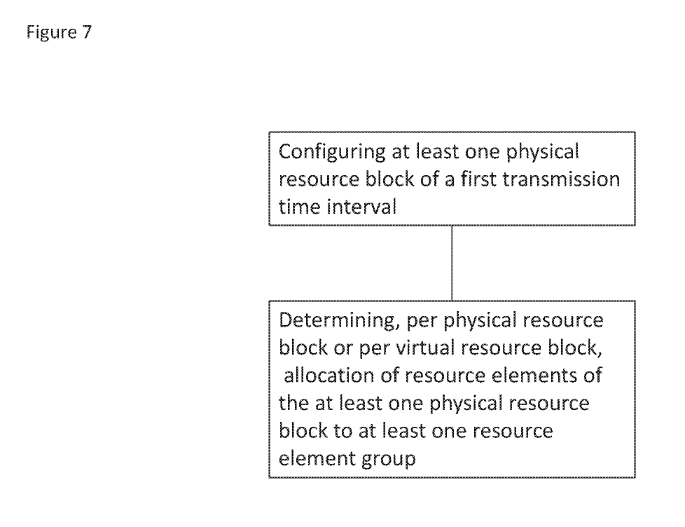

FIG. 7 shows a flowchart of a method of resource element group to resource element mapping for a shortened TTI. The method comprises configuring at least one physical resource block of a first transmission time interval, comprising determining allocation of resource elements of the at least one physical resource block to at least one resource element group per physical resource block or per virtual resource block.

The first transmission time interval may be a shortened TTI. The shortened TTI may comprise between 1 and 7 OFDM symbols. The shortened TTI may be a slot level TTI, that is, equal to the length of a slot of a second, or legacy, transmission time interval, and comprising, e.g., seven OFDM symbols.

The at least one physical resource block may comprise a plurality of resource elements in the frequency domain and all of the symbols, e.g. OFDM symbols, of the first TTI in the time domain. The number of resource elements in the frequency domain may be predefined, and/or may depend on the length of the first TTI.

The virtual resource block may comprise a plurality of physical resource blocks. The physical resource blocks of the virtual resource block may be consecutive or non-consecutive in the frequency domain. The number of physical resource blocks in the virtual resource block may be predefined or depend on the length of the first transmission time interval.

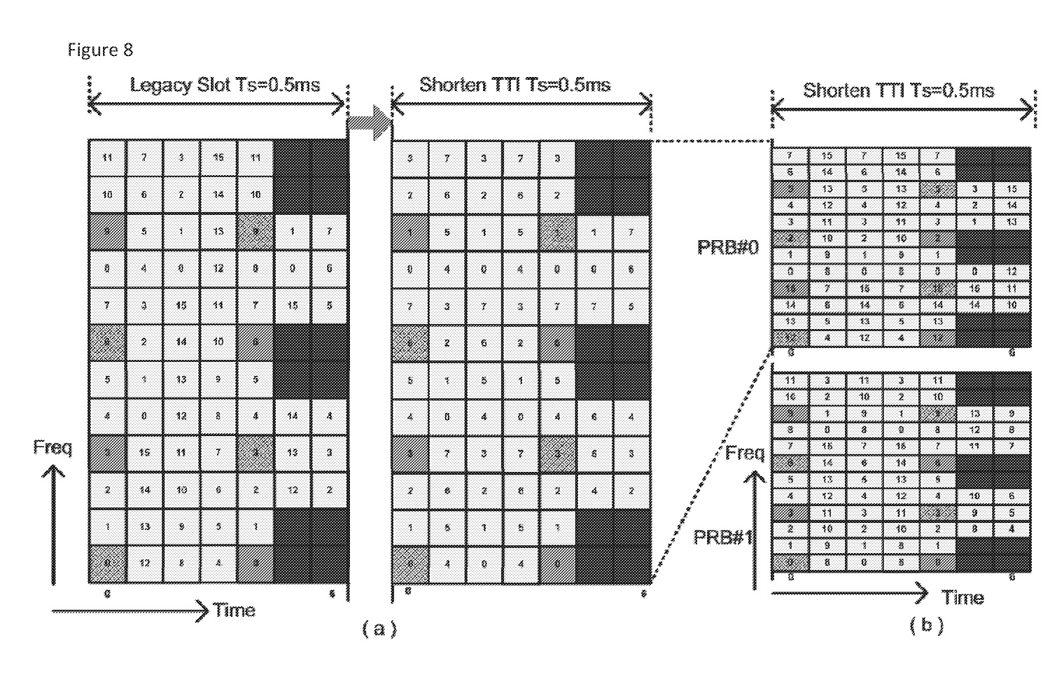

The number of RE comprised in an eREG may be predefined or configured in dependence on the length of the first TTI. The number of resource element groups allocated per physical resource block or per virtual resource block may be predefined or dependent on the index selection from resource element to resource element group mapping. The index selection from resource element to resource element group mapping may be referred to as Idx_{eREG}. Idx_{eREG} may be {3, 7, 15}. If 7 is chosen as the index without virtual PRB combination, then, only 9 REGs left (as shown in FIG. 8), 15 means not all available REs within current PRB can be used for combining REG (72/16 is not integer), which may cause efficiency loss, so virtual PRB unit should be used for Idx_{eREG}=15. The number of REs contained in each physical resource block in the shorten TTI, whether a PRB or a combination of virtual resource blocks, is equal to the number of REs in one legacy PRB.

For a shortened TTI case, e.g. a TTI of 0.5 ms, several PRBs in frequency domain can be combined within one shorten TTI (e.g., 0.5 ms TTI) to form a virtual PRB unit (continuous or non-continuous in frequency domain), or one PRB from a first TTI and one PRB from a second TTI would be grouped as one unit for eREG to eCCE mapping. Taking 4 eREGs per enhanced control channel element (eCCE) as an example, two options are proposed for eREG to RE mapping.

An embodiment of eCCE mapping is shown in FIG. 8a using 8 different eREGs in each shortened TTI. The maximal index number of eREGs for each configured SePDCCH PRB is set as 7 based on index of eREG {0, 1, 2, 3, 4, 5, 6, 7}. The overall index of eREGs is N_{eREG}=└N_{PRB}^{RE}/N_{eREG}^{RE}┘, where N_{eREG} is the number of eREG in each PRB, N_{PRB}^{RE} is the number of REs in each PRB and N_{REG}^{RE} is the number of REs in each eREG. For spectrum efficiency, N_{eREG} may be an integer number.

An embodiment of eCCE mapping is shown in FIG. 8b. Two (or more) consecutive or distributed PRBs (the number of PRBs may depend on TTI length) in the frequency domain are grouped as a unit. The eREG to RE mapping is defined in this unit. In FIG. 8b, PRB#0 and PRB#1 are grouped as a virtual PRB unit and using the legacy 16 eREG index for shortened TTI RE to eREG mapping, then the two (or more) PRBs in the frequency domain are combined together and the counting continued to 15 (eREG index {0, 1, 2, 3, 4, 5, 6, 7, 8, 9, 10, 11, 12, 13, 14, 15} with PRB#0 and PRB#1 combined case is shown in FIG. 8b).

Having frequency non-consecutive mapping grouped as a unit may improve frequency diversity gain in comparison legacy mapping. For example, if there are four PRBs, there are four frequency positions, one for each PRB.

The virtual PRB combination N_{PRB}^{Com}, where N_{PRB}^{Com} is the number of PRB combined, should obey the following rule shown in equation 1 for backward compatibility.

$${N}_{PRB}^{Com} = \frac{{Idx}_{eREG} + 1}{⌊ ( {N}_{PRB}^{RE} - {N}_{RS} ) / {N}_{eREG}^{RE} ⌋} \\ s . t . ( {Idx}_{eREG} + 1 ) mod ⌊ ( {N}_{PRB}^{RE} - {N}_{RS} ) / {N}_{eREG}^{RE} ⌋ = 0 \qquad ( 1 )$$

Idx_{eREG} is the maximal eREG index of each PRB, N_{RS} is the number of REs occupied by legacy reference signals or REs such as DMRS which must be occupied. Idx_{eREG} may be chosen from set {3,7,15}.

In one embodiment, the number of REs contained in each physical resource block (N_{PRB}^{RE}=D_{TTI}×N_{SC}) in the shorten TTI is the one equal to the number of REs in one legacy PRB (N_{PRB}^{RE}=D_{TTI}^{L}×N_{SC}^{L}) and N_{SC}=(D_{TTI}^{L}/D_{TTI})×N_{SC}^{L}·D_{TTI}^{L} is the duration of legacy TTI while the D_{TTI} is the duration for shorten TTI structure (in symbols, ms or time scale), N_{SC}^{L} is the legacy number of sub carriers per legacy PRB, and N_{SC} is the number of sub carriers of shorten TTI PRB.

A non-integer value of (D_{TTI}^{L}/D_{TTI}) may apply to round, ceiling or floor functions in a predetermined way

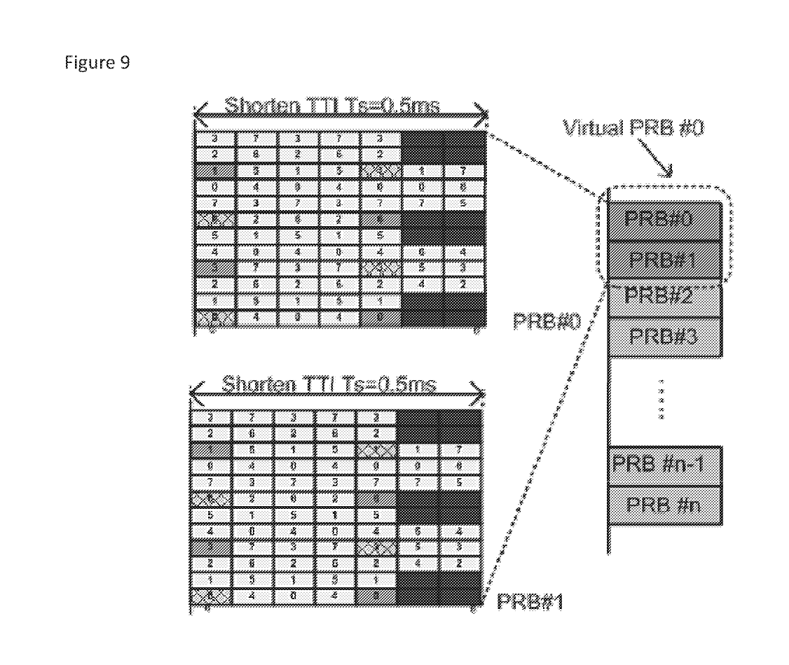

FIG. 9 shows an example of virtual PRB unit combination method to arrive at a physical resource block for a first, or shortened, TTI.

In distributed mode the index may be reduced from {0˜15} to {0˜7} for the embodiment shown in FIG. 8a. For the option shown in FIG. 8b in distributed mode, the legacy index {0˜15} is kept but with doubled (or more) PRBs configuration for ePDCCH.

In localised mode, since legacy localized mode picks up eREGs in one PRB pair, with TTI duration as 0.5 ms configuration, index shall be reduced from {0˜15} to {0˜7} for FIG. 8a. However, FIG. 8b shall not be supported with legacy one eREG including 9 REs configuration (eREG cannot be picked up from single PRB).

The proposed shortened TTI frame structure and ePDCCH allocation methods may be used to implement a latency reduction feature in legacy LTE/LTE-A system. A UE using the proposed shortened TTI frame may follow the legacy LTE/LTE-A network access procedure and control region listening as a legacy UE, while the shorten TTI frame configuration is scheduled by eNB and is transparent to a legacy UE.

Mapping eREG to RE in one shortened TTI may provide shorter and reduced latency in comparison to grouping two shortened TTIs for mapping. Frequency non-consecutive mapping may provide increased frequency diversity gain.

It should be understood that each block of the flowchart of FIG. 7 and any combination thereof may be implemented by various means or their combinations, such as hardware, software, firmware, one or more processors and/or circuitry.

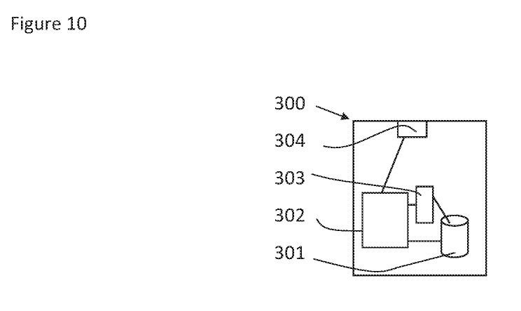

The method may be implemented on a mobile device as described with respect to FIG. 2 or control apparatus as shown in FIG. 10. FIG. 10 shows an example of a control apparatus for a communication system, for example to be coupled to and/or for controlling a station of an access system, such as a RAN node, e.g. a base station or (e) node B, or a node of a core network such as an MME, or a server or host. The method may be implanted in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head. For example the control apparatus 300 can be configured to execute an appropriate software code to provide the control functions. Control functions may comprise configuring at least one physical resource block of a first transmission time interval, comprising determining allocation of resource elements of the at least one physical resource block to at least one resource element group per physical resource block or per virtual resource block.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to LTE/LTE-A similar principles can be applied in relation to other networks and communication systems, for example, 5G networks. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1-31. (canceled)

32. A method comprising:
configuring at least one physical resource block of a first transmission time interval, comprising
determining allocation of resource elements of the at least one physical resource block to at least one resource element group per physical resource block or per virtual resource block.

33. A method according to claim 32, wherein the at least one physical resource block comprises a plurality of resource elements in frequency domain and orthogonal frequency division multiplexing symbols of the first transmission time interval in time domain.

34. A method according to claim 32, wherein the first transmission time interval comprises between 1 and 7 orthogonal frequency division multiplexing symbols.

35. A method according to claim 32, wherein number of resource elements in frequency domain is predefined or dependent on length of the first transmission time interval.

36. A method according to claim 32, wherein the virtual resource block comprises a plurality of physical resource blocks.

37. A method according to claim 32, wherein number of resource elements associated with the at least one resource element group is predefined or dependent on length of the first transmission time interval.

38. A method according to claim 32, wherein number of resource element groups allocated per physical resource block or per virtual resource block is predefined or dependent on index selection from resource element to resource element group mapping.

39. A method according to claim 32, wherein number of resource elements in the at least one physical resource block of the first transmission time interval is equal to the number of resource elements in a physical resource block of a second transmission time interval.

40. A method according to claim 32, wherein the first transmission time interval is equal to length of a slot of a second transmission time interval.

41. An apparatus comprising:
at least one processor and at least one memory including a computer program code, the at least one memory and the computer program code configured to, with the at least one processor, cause the apparatus at least to:
configure at least one physical resource block of a first transmission time interval, comprising
determining allocation of resource elements of the at least one physical resource block to at least one resource element group per physical resource block or per virtual resource block.

42. An apparatus according to claim 41, wherein the at least one physical resource block comprises a plurality of resource elements in frequency domain and orthogonal frequency division multiplexing symbols of the first transmission time interval in time domain.

43. An apparatus according to claim 41, wherein the first transmission time interval comprises between 1 and 7 orthogonal frequency division multiplexing symbols.

44. An apparatus according to claim 41, wherein number of resource elements in frequency domain is predefined or dependent on length of the first transmission time interval.

45. An apparatus according to claim 41, wherein the virtual resource block comprises a plurality of physical resource blocks.

46. An apparatus according to claim 45, wherein the plurality of physical resource blocks of the virtual resource block are frequency consecutive or frequency non-consecutive.

47. An apparatus according to claim 41, wherein number of resource elements associated with the at least one resource element group is predefined or dependent on length of the first transmission time interval.

48. An apparatus according to claim 41, wherein number of resource element groups allocated per physical resource block or per virtual resource block is predefined or dependent on index selection from resource element to resource element group mapping.

49. An apparatus according to claim 41, wherein number of resource elements in the at least one physical resource block of the first transmission time interval is equal to the number of resource elements in a physical resource block of a second transmission time interval.

50. An apparatus according to claim 41, wherein the first transmission time interval is equal to length of a slot of a second transmission time interval.

51. A computer program embodied on a non-transitory computer-readable storage medium, the computer program comprising program code for controlling a process to execute a process, the process comprising:
configuring at least one physical resource block of a first transmission time interval, comprising
determining allocation of resource elements of the at least one physical resource block to at least one resource element group per physical resource block or per virtual resource block.
